(19) United States
(12) Patent Application Publication
(10) Pub. No.: US 2015/0168957 A1
(43) Pub. Date: Jun. 18, 2015

(54) CONTROL PROCESS TO SAVE ELECTRICAL ENERGY CONSUMPTION OF A PUMP EQUIPMENT

(71) Applicant: Schneider Toshiba Inverter Europe SAS, Pacy sur Eure (FR)

(72) Inventors: Francois MALRAIT, Jouy sur Eure (FR); Kamal Ejjabraoui, La Courneuve (FR)

(73) Assignee: Schneider Toshiba Inverter Europe SAS, Pacy sur Eure (FR)

(21) Appl. No.: 14/571,505

(22) Filed: Dec. 16, 2014

(30) Foreign Application Priority Data
Dec. 16, 2013 (FR) 13 62645

(51) Int. Cl. G05D 9/12

(52) U.S. Cl. CPC G05D 9/12

(57) ABSTRACT

The invention relates to a control method for minimizing the electrical energy consumed during a process of filling or draining a tank (R), said process of filling or draining the tank being implemented using a pumping equipment item (EP) which comprises at least one pump, said filling or draining process being performed in the presence of a disturbing flow (Q_{c}) draining the tank or respectively filling the tank, said method consisting in determining an optimum speed (ωopt) of the pumping equipment item that minimizes the electrical energy consumed by the pumping equipment item during the process of filling or draining the tank (R).

### TECHNICAL FIELD OF THE INVENTION

The present invention relates to a control method for minimizing the electrical energy consumed by a pumping equipment item during the process of filling or draining a tank. The invention relates also to the control system which makes it possible to implement this method.

### STATE OF THE ART

There are a certain number of documents describing solutions for minimizing energy consumed during a process of filling or draining a tank.

The patent EP1725774B1 describes a solution in which a number of pumps are started up in sequence as a function of the trend of the level of the liquid in the tank. Each of the pumps is started at an optimum speed which is not readapted according to the tank filling or draining conditions.

The patent application EP2610693A1 describes a method and an apparatus for minimizing the electrical energy consumed by a pumping system associated with the tank. The method notably comprises an identification step making it possible to determine the characteristics of the pump and a step that makes it possible to determine an optimum area of operation of the pump. This solution does not take account of a disturbing flow which is likely to modify the optimum area of operation of the pump.

The aim of the invention is to propose a control method for minimizing the electrical energy consumed by a pumping equipment item during the process of filling or draining a tank, said method making it possible to save electrical energy across the entire range of operation of the pumping equipment item and to operate the pumping equipment item at its optimum point.

### EXPLANATION OF THE INVENTION

This aim is achieved by a control method for minimizing the electrical energy consumed during a process of filling or draining a tank, said process of filling or draining the tank being implemented using a pumping equipment item which comprises at least one pump, one electric motor actuating said pump and one actuator controlling said electric motor, said filling or draining process being performed in the presence of a disturbing flow draining the tank or respectively filling the tank, said method consisting in determining an optimum speed of the pumping equipment item that minimizes the electrical energy consumed by the pumping equipment item during the process of filling or draining the tank, said optimum speed being a function:
of the volume of liquid in the tank,
of the tank filling flow or draining flow,
of the disturbing flow,
of the instantaneous power consumed by the pumping equipment item.

In the case of a process of filling the tank, the optimum speed is expressed as follows:

$$\frac{\frac{d}{d ω} ( p ( ω , V ) ) \cdot ( {Q}_{input} ( ω , V ) - {Q}_{c} ) - p ( ω , V ) \cdot \frac{d}{d ω} ( {Q}_{input} ( ω , V ) )}{{( {Q}_{input} ( ω , V ) - {Q}_{c} )}^{2}} = g ( V , ω )$$

In which:
V represents the volume of liquid in the tank,
g represents a zero mean function in the variable V over the interval [0−Vmax],
ω represents the speed of the pump of the pumping equipment item,
Qᵢₙₚᵤₜ represents a tank filling flow,
Q_{c} represents the disturbing flow,
p represents the instantaneous power consumed by the pumping equipment item.

The invention relates also to a control system for a pumping equipment item that makes it possible to minimize the electrical energy consumed during a process of filling or draining a tank, said equipment item comprising at least one pump, one electric motor actuating said pump and one actuator controlling said electric motor, said filling or draining process being performed in the presence of a disturbing flow draining the tank or respectively filling the tank, said system comprising a control unit comprising a module for determining an optimum speed of the pumping equipment item that minimizes the electrical energy consumed by the pumping equipment item during the process of filling or draining the tank, said optimum speed being a function:
of the volume of liquid in the tank,
of the tank filling flow or draining flow,
of the disturbing flow,
of the instantaneous power consumed by the pumping equipment item.

According to a particular feature of the invention, the disturbing flow can be obtained by estimation using a software estimation module.

### BRIEF DESCRIPTION OF THE FIGURES

Other features and advantages will emerge from the following detailed description given in light of the attached drawings in which:

FIGS. 1A and 1B schematically represent the principle of pumping of a tank, respectively for the tank filling process and for the tank draining process,

FIG. 1C illustrates the expression of the static pressure of a tank,

FIG. 2 schematically represents a pumping equipment item comprising a plurality of single-pump cells assembled in parallel,

FIG. 3 represents a block diagram illustrating the control method of the invention,

FIG. 4 represents curves showing the variation of the optimum speed of the pump as a function of the static pressure of the pump and of the disturbing flow during the process of filling the tank;

FIG. 5 represents curves showing the variation of the optimum speed of a pump in operation, of two pumps in operation or of three pumps in operation, as a function of the disturbing flow during the process of filling a tank,

FIG. 6 represents curves showing the variation of the optimum electrical energy consumed for one pump in operation, two pumps in operation or three pumps in operation, as a function of the disturbing flow during the process of filling a tank.

### DETAILED DESCRIPTION OF AT LEAST ONE EMBODIMENT

The invention is linked to the process of filling or of draining a tank R implemented using a pumping equipment item EP. The invention is particularly applicable in the field of the treatment of waste water or of portable water storage.

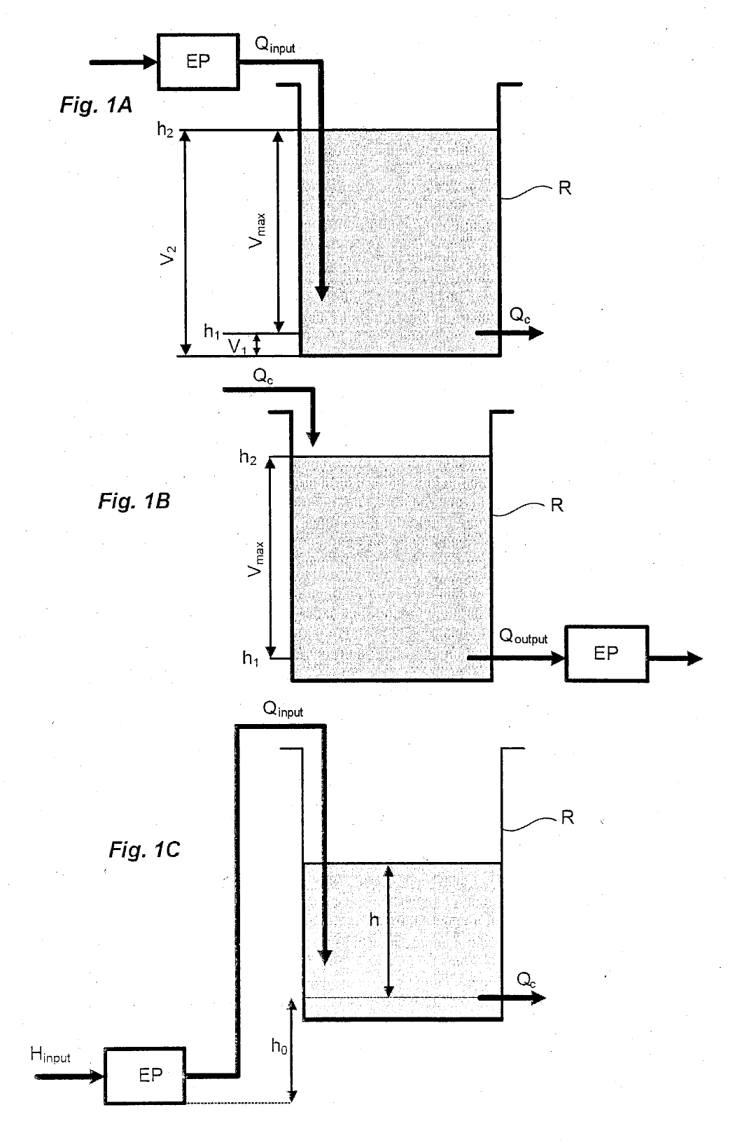

With reference to FIG. 1A, the process of filling a tank R consists in generating, using the pumping equipment item EP, a filling flow Qᵢₙₚᵤₜ of a liquid to the interior of the tank R. A disturbing flow Q_{c} draining the tank R disturbs this normal filling process.

With reference to FIG. 1B, the process of draining a tank R consists in generating, using the pumping equipment item EP, a draining flow Qₒᵤₜₚᵤₜ for draining the liquid contained in the tank R. Likewise, a disturbing flow Q_{c} filling the tank disturbs this normal draining process.

In the filling process, when the level of liquid drops below a low limit value h₁, the pumping equipment item EP has to be activated to fill the tank until the level of liquid exceeds a high limit value h₂.

In the draining process, when the level of-liquid rises above the high limit value h₂, the pumping equipment item is activated to drain the tank until the level of liquid drops back below the low limit value h₁.

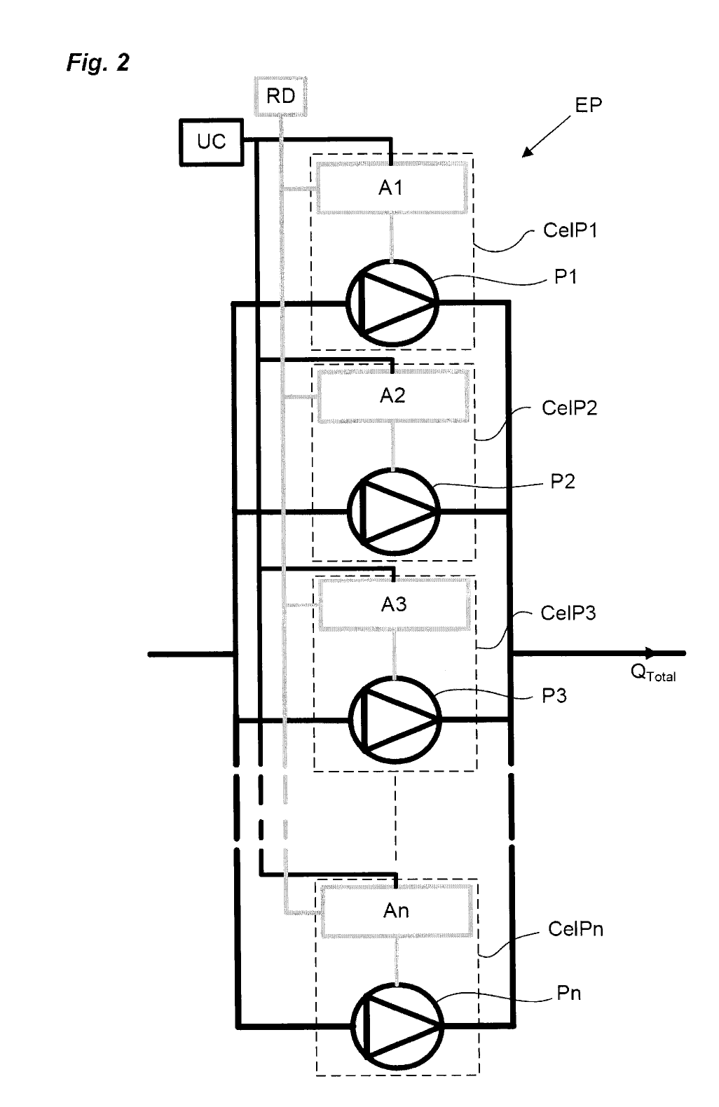

With reference to FIG. 2, a pumping equipment item EP comprises one or more single-pump cells CelP1, CelP2, . . . , CelPn. A single-pump cell comprises a pump P1, P2, . . . , Pn, an electric motor actuating the pump and an actuator A1, A2, . . . An, controlling the electric motor. In FIG. 2, the electric motor of each single-pump cell is incorporated in the pump. The actuator can be a variable speed drive, a starter, a contactor or any other power conversion device making it possible to supply power to the electric motor. In the context of the invention, in order to be able to vary the speed of at least one pump, at least one of the actuators has to consist of a variable speed drive.

As represented in FIG. 2, the pumping equipment item EP can comprise a plurality of single-pump cells connected in parallel to the electrical distribution network RD. The set of single-pump cells generates a total flow Q_{Total}, corresponding to the filling flow or to the draining flow of the tank R.

The invention is applied for a pumping equipment item with one or more single-pump cells.

A control system, associated with the pumping equipment item EP, is arranged to implement the control method of the invention. This control system mainly comprises:
means for measuring or estimating the static pressure Hₚᵤₘₚ of the pumping equipment item EP,
means for measuring or estimating the disturbing flow Q_{c},
a control unit UC executing at least one software module to determine the optimum speed ωₒₚₜ to be applied to the pumping equipment item to minimize the electrical energy consumed by this equipment item EP.

The control unit UC, implementing the control method of the invention, is responsible for controlling the actuators of the single-pump cells. In FIG. 2, the control unit UC is dissociated from the single-pump cells and is connected to each actuator of the single-pump cells in order to be able to send them control signals.

The control method of the invention, that makes it possible to minimize the electrical energy consumed by the pumping equipment item EP, is explained in more detail hereinbelow.

The energy consumed in the case of a single-pump cell is expressed by the following relationship (1):

$$\frac{d {E}_{MonoCell}}{d t} = {P}_{pump} + {P}_{MotorLosses} + {P}_{ActuatorLosses} \qquad ( 1 )$$

### With:

E_{MonoCell}: the energy consumed by a single-pump cell [Wh],
P_{MotorLosses}: the joule losses in the motor [W] of the single-pump cell, which depend on the operating point defined by the speed and the power of the pump,
P_{ActuatorLosses}: the joule losses in the actuator [W] of the single-pump cell, which depend on the operating point defined by the speed and the power of the pump,
Pₚᵤₘₚ: the power consumed by the pump of the single-pump cell [W], which depends on the operating point defined by the speed and the level of static pressure of the pumping equipment item.

The overall energy consumed in the case of a pumping equipment item with a plurality of single-pump cells is then expressed by the following relationship (2):

$$\frac{d E}{d t} = p = {\sum }_{1}^{M} {P}_{pump} + {\sum }_{1}^{M} {P}_{MotorLosses} + {\sum }_{1}^{M} {P}_{ActuatorLosses} \qquad ( 2 )$$

### With:

E: the energy consumed by the pumping equipment item [Wh],
p: the instantaneous power consumed by the pumping equipment item [W].

The invention aims to continuously determine the optimum speed ωₒₚₜ at which at least one pump of the pumping equipment item EP should rotate to fill and/or drain the tank R while saving electrical energy consumed by the pumping equipment item EP, regardless of the value of the disturbing flow Q_{c} and that of the static pressure applied Hₚᵤₘₚ to this pumping equipment item EP.

The technical problem therefore consists in finding the speed trajectory which minimizes the electrical energy consumed to fill or drain the tank R.

In the case of the process of filling a tank R, the following expression (3) applies:

$$\frac{d V}{d t} = {Q}_{input} ( ω , {H}_{pump} ) - {Q}_{c} \qquad ( 3 )$$

In the case of the process of draining a tank R, the following expression (4) applies:

$$\frac{d V}{d t} = {Q}_{c} - {Q}_{output} ( ω , {H}_{pump} ) \qquad ( 4 )$$

### With:

V: volume of liquid in the tank [m³] (Vₘₐₓ being equal to V₂−V₁, the difference between the volume at a so-called high level and the volume at a so-called low level),
Q_{c}: the disturbing flow [m³/s],
Qᵢₙₚᵤₜ: the filling flow [m³/s] which depends on the speed ω of the pumping equipment item and on the static pressure Hₚᵤₘₚ of the pumping equipment item,
Qₒᵤₜₚᵤₜ: the draining flow [m³/s] which depends on the speed ω and on the static pressure Hₚᵤₘₚ of the pumping equipment item.

As a general rule, the height of liquid in the tank can be expressed as a function of the volume contained therein. Hereinbelow, we take the case of a symmetrical tank R, for which the quantity V (i.e. the volume) is expressed as follows:

V=S·h (5)

### With:

h: the height [m] of liquid in the tank, the heights h1, respectively h2, corresponding to the volumes V1, respectively V2,
S: section of the tank [m²].

With reference to FIG. 1C, the static pressure of the pumping equipment item is expressed as a function of the height of liquid in the tank R:

$$\begin{matrix}{H}_{pump} = f ( h ) = {H}_{0} - {H}_{input} + ρ \cdot g \cdot h or & ( 6 ) \\ {H}_{pump} = f ( V ) = {H}_{0} - {H}_{input} + ρ \cdot g \cdot \frac{V}{S} & ( 7 )\end{matrix}$$

### With:

H₀: the pressure drop due to the geometrical height h₀ between the pumping point and the installation of the pumping equipment item [Pa], which is a function of the geometrical height h₀.
Hᵢₙₚᵤₜ: the pressure at the input of the pumping equipment item [Pa],
ρ: the density of the fluid [kg/m³],
g: the gravity [m/s²].

The following demonstration is applied to the process of filling a tank R but it must be understood that it can be applied easily to the process of draining the tank, by reversing the effect of the disturbing flow.

The equations (2) and (3) above can be recombined as follows:

$$\begin{matrix}\frac{d E}{d V} = {E}_{v} \\ = \frac{p ( ω , {H}_{pump} )}{{Q}_{input} ( ω , {H}_{pump} ) - {Q}_{c}} ↔ \frac{d E}{d V} \\ = {E}_{v} \\ = \frac{p ( ω , V )}{{Q}_{input} ( ω , V ) - {Q}_{c}}\end{matrix} \qquad ( 8 )$$

which is expressed as below as an integral function taking into account the variable of the volume of liquid in the tank:

E=∫₀^{V}^{ₘₐₓ}EᵥdV (9)

With the function Qᵢₙₚᵤₜ(ω, V) which is expressed as follows in the case of a pumping equipment item EP with a plurality of single-pump cells:

$${Q}_{input} ( ω , V ) = {Q}_{Total} ( ω , V ) = {\sum }_{i = 1}^{M} {Q}_{pump \_ i} ( {ω}_{i} , V ) \qquad ( 10 )$$

The objective is to minimize the overall energy E during the filling or draining process, which is expressed by cancelling the partial derivative of the energy function relative to the speed variable.

$$\frac{d E}{d ω} = {\int }_{0}^{{V}_{max}} \frac{d {E}_{v}}{d ω} d V = 0 \qquad ( 11 )$$

This general solution can be expressed by a periodic function g in such a way that:

$$\frac{d {E}_{v}}{d ω} = g ( V , ω ) , such that {\int }_{0}^{{V}_{max}} g ( V , ω ) d V = 0 with \\ \frac{d {E}_{v}}{d ω} = \frac{d}{d ω} ( \frac{p ( ω , V )}{{Q}_{input} ( ω , V ) - {Q}_{c}} ) \\ \frac{d {E}_{v}}{d ω} = \frac{\begin{matrix}\frac{d}{d ω} ( p ( ω , V ) ) \cdot ( {Q}_{input} ( ω , V ) - {Q}_{c} ) - \\ p ( ω , V ) \cdot \frac{d}{d ω} ( {Q}_{input} ( ω , V ) )\end{matrix}}{{( {Q}_{input} ( ω , V ) - {Q}_{c} )}^{2}} \qquad ( 12 )$$

The general solution consists in finding the trajectory ω=f(V) verifying the relationship (12):

$$\frac{\begin{matrix}\frac{d}{d ω} ( p ( ω , V ) ) \cdot ( {Q}_{input} ( ω , V ) - {Q}_{c} ) - \\ p ( ω , V ) \cdot \frac{d}{d ω} ( {Q}_{input} ( ω , V ) )\end{matrix}}{{( {Q}_{input} ( ω , V ) - {Q}_{c} )}^{2}} = g ( V , ω ) \qquad ( 13 )$$

A particular solution of (13) consists in minimizing the energy/volume consumed Eᵥ during the process of filling or draining a volume defined by Vₘₐₓ; that is to say in considering g(V, ω))=0.

This amounts to stating that, for a static pressure of the pump Hₚᵤₘₚ (i.e. a given volume), the aim is to cancel the following term:

$$\frac{d {E}_{V}}{d ω} = 0$$

If we take

$${p}^{′} ( ω , V ) = \frac{d}{d ω} ( p ( ω , V ) ) and {Q}_{input}^{′} ( ω , V ) = \frac{d}{d ω} ( {Q}_{input} ( ω , V ) ) ,$$

then a solution to the problem of minimizing the electrical energy consumed is defined by the implicit formula below, derived from (13):

p′(ωₒₚₜ, V)·(Qᵢₙₚᵤₜ(ωₒₚₜ, V)−Q_{c})−p(ωₒₚₜ, V)·Qᵢₙₚᵤₜ′(ωₒₚₜ, V)=0

The speed ω that makes it possible to cancel this term corresponds to the optimum speed ωₒₚₜ at which the pump should rotate to fill the tank while consuming less energy.

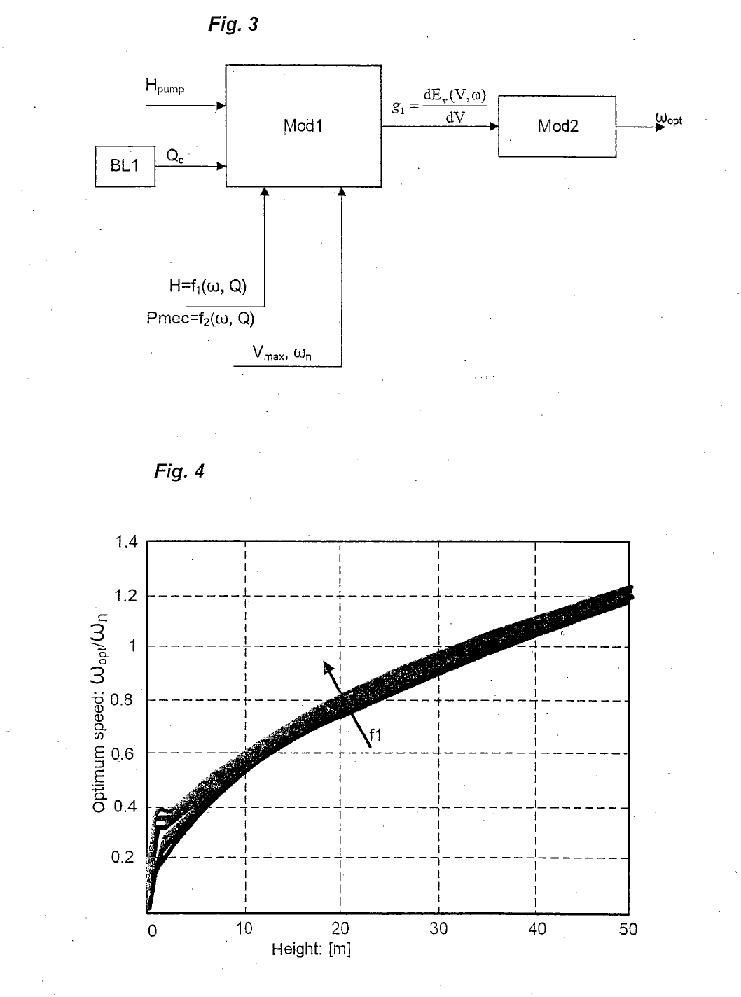

FIG. 3 schematically represents the control method implemented in the control unit UC to determine the optimum speed to be applied to the pumping equipment item EP to minimize the electrical energy consumed.

To control the pumping equipment item EP, the control unit UC receives as input:
the value of the static pressure Hₚᵤₘₚ of the pumping equipment item EP measured by the measurement means,
the value of the disturbing flow Q_{c} measured by the measurement means or estimated using an estimator,
the known characteristics of the pumping equipment item EP, notably the pump curves f₁ and f₂, that is to say the expression of the pressure and of the mechanical power developed by each pump as a function of its speed and of the flow generated,
the application data, for example the volume V of liquid in the tank R, the section S of the tank R and the maximum height hₘₐₓ, the nominal speed ωₙ of each pump.

The functions f₁ and f₂ define the characteristic curves of the pump (H=f₁(ω, Q) and Pmec=f₂(ω, Q). They can be either analytical interpolation functions, or numerical data tables. The function g₁ expresses the energy/volume consumed over the entire range of variation of the speed (from zero to nominal speed ωₙ of the pump and, for all the volumes of liquid contained in the tank; it can be defined as a function of these two variables or a numerical data table. It is determined by a first computation module Mod1 of the control unit from the data described above.

Next, the control unit executes a determination module Mod2 for determining the optimum speed ωₒₚₜ to be applied to the pumping equipment item EP which makes it possible to minimize the electrical energy consumed by the pumping equipment item EP during the process of filling or draining the tank R for a given value Hₚᵤₘₚ. This determination module Mod2 determines the optimum speed ωₒₚₜ which verifies the relationship (13) described above.

The block BL1 can be either a measurement means, or an estimator of, the disturbing flow Q_{c}.

An example of an estimator of the disturbing flow is given by the following system:

$$\frac{d \hat{V}}{d t} = {Q}_{input} ( ω , {H}_{pump} ) - {\hat{Q}}_{c} - {K}_{1} \cdot ( \hat{V} - V )$$

$$\frac{d {\hat{Q}}_{c}}{d t} = - {K}_{2} \cdot ( \hat{V} - V )$$

in which V and Qᵢₙₚᵤₜ(ω, Hₚᵤₘₚ) are known variables and \hat{V} and \hat{Q}_{c} are estimated data.

To better understand the invention, we process two examples below. In the first example the following choices are made:
a zero disturbing flow (Q_{c}=0),
a pumping equipment item with one single-pump cell (pump designated pump_1),
   the relationship (10) becomes:

Qᵢₙₚᵤₜ(ω, V)=Qₚᵤₘₚ_{_{—}}₁(ω₁, V)
to neglect the losses of the actuators and of the electric motors
   the relationship (2) becomes:

p(ω, V)=Pₚᵤₘₚ_{_{—}}₁

Optimizing the filling energy amounts to resolving the relationship (13):

p′(ωₒₚₜ, V)·Qₚᵤₘₚ_{_{—}}₁(ωₒₚₜ, V)−p(ωₒₚₜ, V)·Qₚᵤₘₚ_{_{—}}₁′(ωₒₚₜ, V)=0

which is equivalent to:

$$\frac{d}{d ω} ( \frac{p ( ω , V )}{{Q}_{pump \_ 1} ( ω , V )} ) = 0$$

or even to:

$${H}_{pump \_ 1} ( V ) \frac{d}{d ω} ( \frac{p ( ω , V )}{{H}_{pump \_ 1} ( V ) \cdot {Q}_{pump \_ 1} ( ω , V )} ) = 0$$

By definition, the efficiency of the pump is defined by the ratio:

$$η ( ω , V ) = \frac{{H}_{pump \_ 1} ( V ) \cdot {Q}_{pump \_ 1} ( ω , V )}{p ( ω , V )}$$

The optimum speed is then defined by the following relationship:

$$\frac{d}{d ω} ( η ( ω , V ) ) = 0$$

The optimum efficiency point at nominal speed (ωₙ, H_{BEP}, Q_{BEP}) is solution to this equation. The laws of affinity make it possible to extend the solution and the optimum speed is then expressed as follows:

$${ω}_{opt} = {ω}_{n} \cdot \sqrt{\frac{{H}_{pump \_ 1}}{{H}_{BEP}}}$$

### With:

ωₒₚₜ: the optimum speed at which the pump should rotate for a given static pressure Hₚᵤₘₚ,
ωₙ: the nominal speed of the pump,
Hₚᵤₘₚ_{_{—}}₁: the static pressure of the pump,
H_{BEP}: the static pressure corresponding to the point of optimum operation (maximum efficiency) at the nominal speed.

In a second example, the following choices are made:
a non-zero disturbing flow,
a pumping equipment item with N single-pump cells, in which the N actuators are identical and the N pumps are identical, rotating at the same speed,
   the relationship (10) becomes:

Qᵢₙₚᵤₜ(ω, V)=Σᵢ₌₁^{N}Qₚᵤₘₚ_{_{—}}ᵢ(ωᵢ, V)=N Qₚᵤₘₚ(ωᵢ, V)
to neglect the losses of the actuators and of the electric motors.
   the relationship (2) becomes:

p(ω, V)=Σᵢ₌₁^{N}Pₚᵤₘₚ_{_{—}}ᵢ(ωᵢ, V)=N Pₚᵤₘₚ(ωᵢ, V)

This amounts to resolving the relationship (13) written above:

p′(ωₒₚₜ, V)·(Qᵢₙₚᵤₜ(ωₒₚₜ, V)−Q_{c})−p(ωₒₚₜ, V)·Qᵢₙₚᵤₜ′(ωₒₚₜ, V)=0

which is equivalent to:

$$\frac{d}{d ω} ( \frac{{NP}_{pump} ( ω , V )}{{NQ}_{pump} ( ω , V ) - {Q}_{c}} ) = 0$$

or to:

$$\frac{d}{d ω} ( \frac{{P}_{pump} ( ω , V )}{{Q}_{pump} ( ω , V ) - \frac{{Q}_{c}}{N}} ) = 0$$

That is to say that the disturbing flow influences the multi-pump system inversely proportionally to the number of pumps.

It is deduced therefrom that the overall energy consumed by N pumps is equivalent to that consumed by a single pump with Q_{ceq}=Q_{c}/ N.

By introducing the expression of the efficiency of the pump, we obtain the following relationship:

$$\frac{d}{d ω} ( \frac{1}{η ( ω , V )} \frac{{Q}_{pump} ( ω , V )}{{Q}_{pump} ( ω , V ) - \frac{{Q}_{c}}{N}} ) = 0$$

Which leads to the following expression:

$$\frac{d}{d ω} ( η ( ω , V ) ) = - η ( ω , V ) \frac{\frac{d}{d ω} ( {Q}_{pump} ( ω , V ) )}{{Q}_{pump} ( ω , V )} \frac{\frac{{Q}_{c}}{3}}{{Q}_{pump} ( ω , V ) - \frac{{Q}_{c}}{N}}$$

showing that the optimum of the pumping system is reached for a point which is not the optimum

$$( \frac{d}{d ω} ( η ( ω , V ) ) = 0 )$$

of each pump taken individually.

The optimum speed is obtained by resolving the following relationship:

$${p}^{′} ( {ω}_{opt} , V ) ( {Q}_{pump} ( {ω}_{opt} , V ) - \frac{{Q}_{c}}{N} ) - p ( {ω}_{opt} , V ) \cdot {Q}_{pump}^{′} ( {ω}_{opt} , V ) = 0$$

Knowing the expressions:
of the power of a pump as a function of its volume, i.e. of its pressure, and of its speed,
of the flow rate of a pump as a function of its volume, i.e. of its pressure, and of its speed,
of the disturbing flow,
   it is possible to calculate the following expression:

$${p}^{′} ( {ω}_{opt} , V ) ( {Q}_{pump} ( {ω}_{opt} , V ) - \frac{{Q}_{c}}{N} ) - p ( {ω}_{opt} , V ) \cdot {Q}_{pump}^{′} ( {ω}_{opt} , V )$$

The solution is obtained by finding the speed which cancels this expression.

From this second example, FIG. 4 is then obtained which shows a number of curves expressing the variation of the optimum speed ωₒₚₜ as a function of the height (that is to say of the static pressure of the pump), each curve being obtained with a determined disturbing flow Q_{c}. The arrow f1 is representative of an increase in the disturbing flow Q_{c}. It will be noted in this FIG. 4 that an increase in the disturbing flow Q_{c} entails .a readjustment of the optimum speed. The taking into account of the disturbing flow is therefore necessary to minimize the electrical energy consumed by the pumping equipment item.

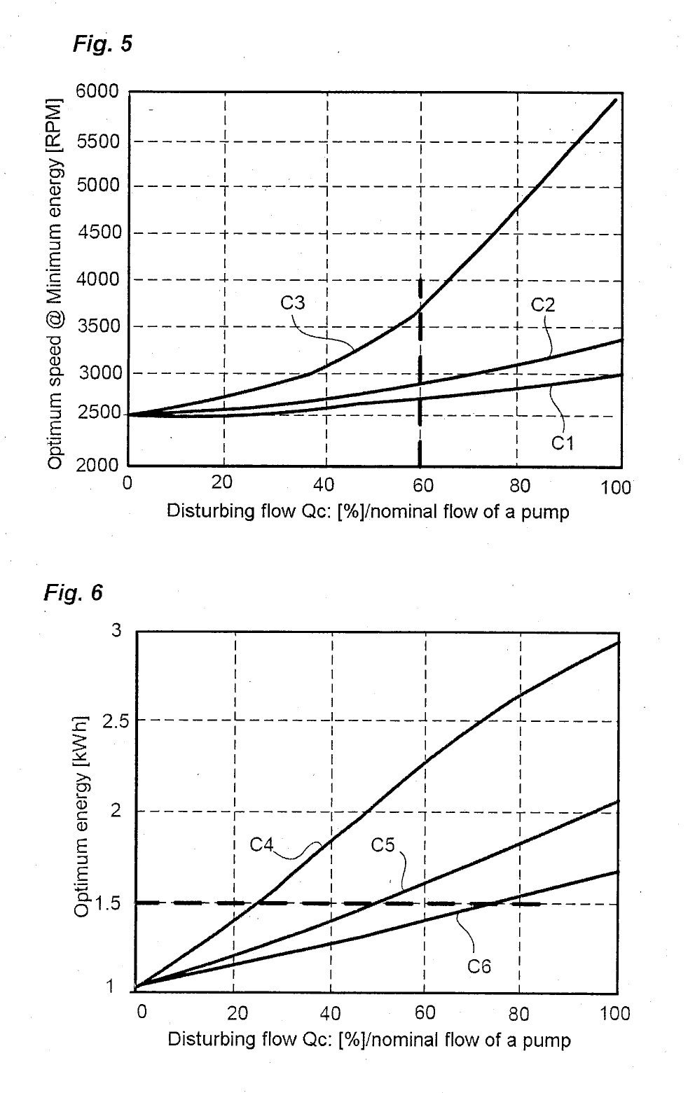

For a given static pressure Hₚᵤₘₚ (that is to say a volume), FIGS. 5 and 6 give, respectively, the optimum speed and the energy consumed as a function of the disturbing flow Q_{c} in the case of a single pump, of two pumps and of three pumps.

It will be noted in FIGS. 5 and 6 that, for one and the same disturbing flow Q_{c}, it is more advantageous to operate three pumps at a low optimum speed than a single pump at a higher optimum speed. For example, in FIG. 5, for a disturbing flow at 60% of the nominal flow of a pump, the actuation of three pumps (curve C1) at the optimum speed of approximately 2700 revolutions per minute (RPM) will cause less electrical energy to be consumed than the actuation of two pumps (curve C2) at a speed of approximately 2800 revolutions per minute and less electrical energy than the actuation of a single pump (curve C3) at the optimum speed of 4700 revolutions per minute.

For example, in FIG. 6, the consumption of an electrical energy of 1.5 kWh makes it possible to generate a disturbing flow of 25% if a single pump is employed (curve C4), a disturbing flow of 50% if two pumps are employed (curve C5) and a disturbing flow of 75% if three pumps (curve C6) are employed. This justifies the benefit of the actuation of a plurality of pumps at the optimum speed in order to minimize the electrical energy consumed.

1. Control method for minimizing the electrical energy consumed during a process of filling or draining a tank (R), said process of filling or draining the tank being implemented using a pumping equipment item (EP) which comprises at least one pump, one electric motor actuating said pump and one actuator controlling said electric motor, said filling or draining process being performed in the presence of a disturbing flow (Q_{c}) draining the tank or respectively filling the tank, said method being characterized in that it consists in determining an optimum speed (ωopt) of the pumping equipment item that minimizes the electrical energy consumed by the pumping equipment item during the process of filling or draining the tank (R), said optimum speed being a function:
of the volume (V) of liquid in the tank,
of the tank filling flow (Qᵢₙₚᵤₜ) or draining flow (Qₒᵤₜₚᵤₜ),
of the disturbing flow (Q_{c}),
of the instantaneous power (p) consumed by the pumping equipment item.

2. Method according to claim 1, characterized in that it comprises a step of determining the disturbing flow by estimation.

3. Control system for a pumping equipment item that makes it possible to minimize the electrical energy consumed during a process of filling or draining a tank, said equipment item comprising at least one pump, one electric motor actuating said pump and one actuator controlling said electric motor, said filling or draining process being performed in the presence of a disturbing flow draining the tank or respectively filling the tank, said system being characterized in that it comprises a control unit (UC) comprising a module (Mod2) for determining an optimum speed (ωopt) of the pumping equipment item that minimizes the electrical energy consumed by the pumping equipment item during the process of filling or draining the tank (R), said optimum speed being a function:
of the volume (V) of liquid in the tank,
of the tank filling flow (Qᵢₙₚᵤₜ) or draining flow (Qₒᵤₜₚᵤₜ),
of the disturbing flow (Q_{c}),
of the instantaneous power (p) consumed by the pumping equipment item.

4. System according to claim 4, characterized in that the control unit comprises a module for estimating the disturbing flow.
